(19) United States
(12) Patent Application Publication
(10) Pub. No.: US 2004/0031477 A1
(43) Pub. Date: Feb. 19, 2004

(54) Adjustable BBQ grill

(76) Inventor: Jui-Ju Yeh, Taipei (TW)

Correspondence Address: DELLETT AND WALTERS, 310 S.W. FOURTH AVENUE, SUITE 1101, PORTLAND, OR, 97204, US

(21) Appl. No.: 10/222,686

(22) Filed: Aug. 15, 2002

(51) Int. Cl. F24C 3/00; A47J 37/00

(52) U.S. Cl. 126/25 R; 126/41 R

(57) ABSTRACT

An adjustable grill has a metal plate with a through hole defined in a center of the metal plate, multiple elongated pivoting bars each securely engaged with a plate which is arranged to cover the through hole, two control bars securely and pivotally located on opposite sides defining the through hole to respectively and pivotally connect to opposite distal ends of the multiple plates and a control knob connected to one of the elongated pivoting bars and extending out of the metal plate so that the user is able to control the dimension of the gaps between two adjacent plates by pivoting the control knob.

### BACKGROUND OF THE INVENTION

1. Field of the Invention

The present invention relates to a barbecue grill, and more particularly to an adjustable barbecue grill which is able to control flame volume to the food on the grill.

2. Description of Related Art

A conventional BBQ grill is made of an iron wire with multiple holes defined in a center thereof to support thereon the food to be roasted. However, when using this kind of conventional grill, the user will have difficulties trying to hold the grill in hand so as to control the roasted area on the food. As a result, the user often will have the food overdone or the user will have to wait for a long time for the food to become eatable. That is, a general problem which we are all going to encounter, there is nothing we can do to control the flame volume. If the flame volume is too big, the food is quickly roasted and most of the time the food is overdone. If the flame volume is too small, the user might need a lot of time waiting for the food to become eatable or the user will have to think of a way to reduce the distance between the grill and the flame so as to reduce the time for the food to become eatable.

To overcome the shortcomings, the present invention tends to provide an improved ornamental adjustable barbecue grill to mitigate and obviate the aforementioned problems.

### SUMMARY OF THE INVENTION

The primary objective of the present invention is to provide an adjustable barbecue grill, wherein gaps between two adjacent plates are able to be adjusted so that the flame volume to the food is controlled.

In order to accomplish the foregoing objective, the grill of the present invention has a metal plate with a through hole defined in a center of the metal plate, multiple elongated pivoting bars each securely engaged with a plate which is arranged to cover the through hole, two control bars securely and pivotally located on opposite sides defining the through hole to respectively and securely connect to distal ends of the multiple plates and a control knob connected to one of the elongated pivoting bars and extending out of the metal plate so that the user is able to control the dimension of the gaps between two adjacent plates by pivoting the control knob.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view showing the adjustable barbecue grill together with a barbecue stove;

FIG. 2 is a perspective view of the adjustable barbecue grill with partial in section;

FIG. 3 is a schematic cross sectional view showing the structure of the BBQ grill;

FIG. 4 is a schematic view showing that the gap between two adjacent plates is adjusted by pivoting the control knob;

FIG. 5 is a schematic view showing that the gap is adjusted to its maximum;

FIG. 6 is a schematic view showing that a food is placed on top of the grill with the gaps between two adjacent plates closed;

FIG. 7 is a schematic view showing that the gaps between two adjacent plates are adjusted so that the food may be prepared in a short period of time; and

FIG. 8 is a schematic view showing that the gap is adjusted to it maximum.

### DETAILED DESCRIPTION OF THE PREFERRED EMBODIMENT

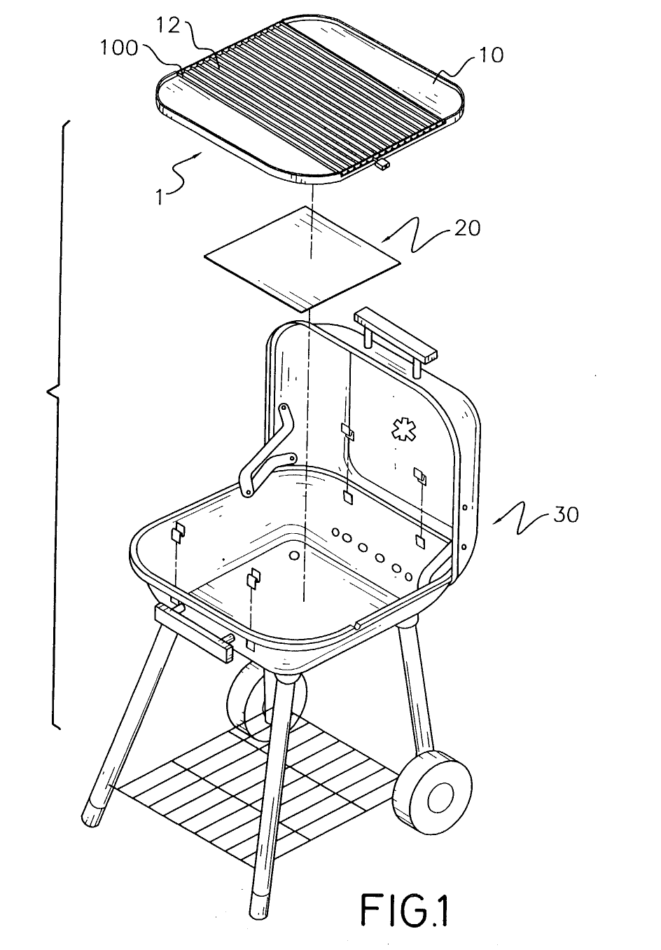

With reference to FIG. 1, a complete barbecue set includes a barbecue grill (1), a charcoal plate (20) and a barbecue stove (30). However, since both the charcoal plate (20) and the barbecue stove (30) are not the focus of the present invention, detailed description thereof is omitted.

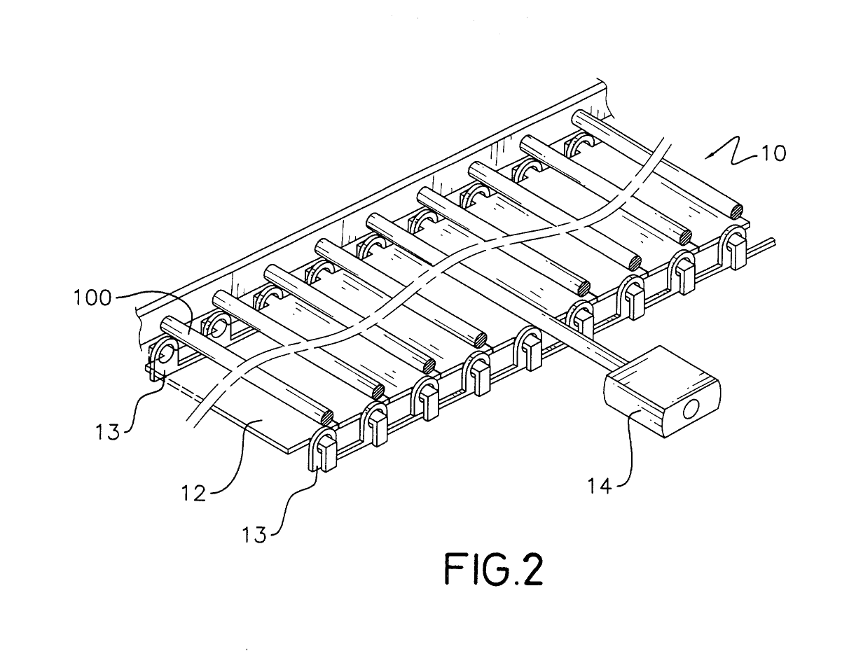

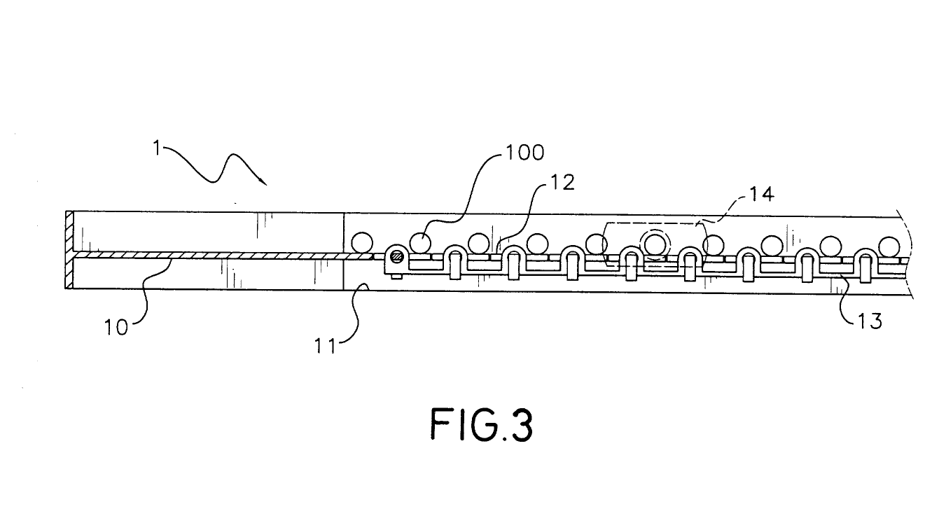

With reference to FIGS. 2, 3 and still taking FIG. 1 for reference, it is noted that the grill (1) in accordance with the present invention has a metal plate (10) with a through hole (11) defined in a center of the metal plate (10), multiple elongated pivoting bars (100) each securely attached to a side face of a plate (12) which is arranged to cover the through hole (11), two control bars (13) securely and pivotally located on opposite sides defining the through hole (11) to respectively and pivotally connect to opposite distal ends of the multiple plates (12) and a control knob (14) connected to one of the elongated pivoting bars (100) and extending out of the metal plate (10) so that the user is able to control the dimension of a gap defined between two adjacent plates (12) by pivoting the control knob (14).

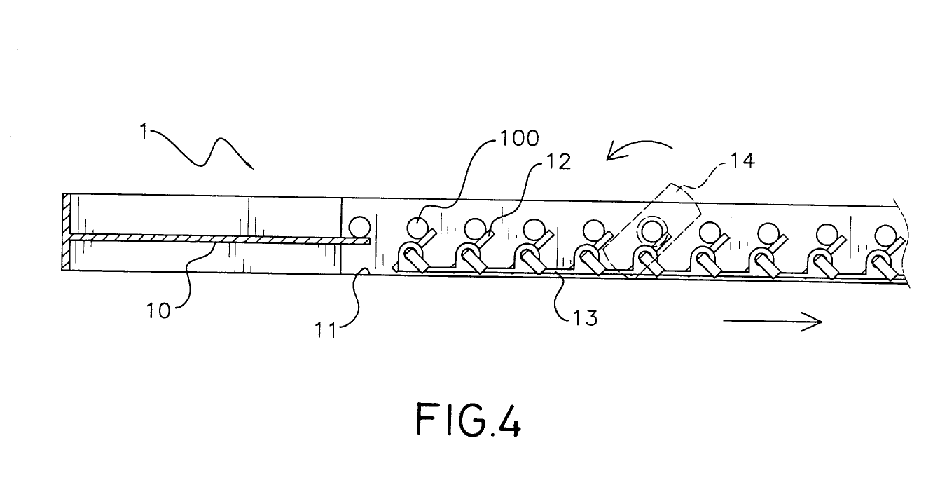

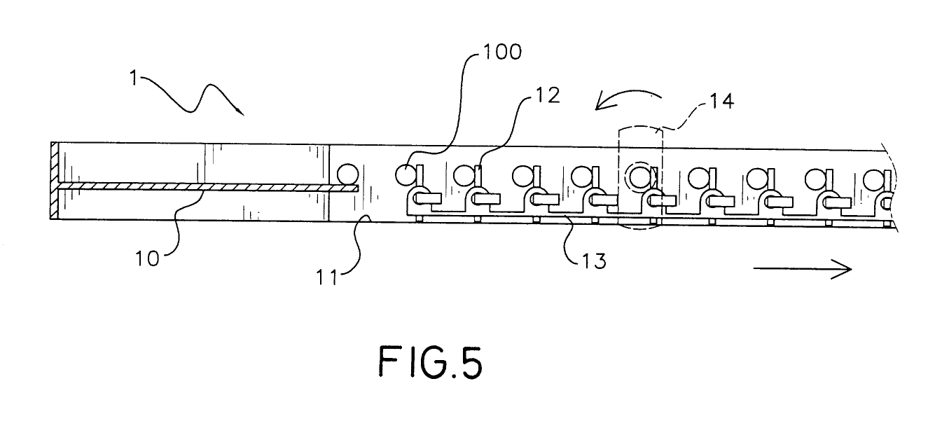

With reference to FIGS. 4 and 5, pivoting the control knob (14) activates the pivotal movement of the plates (12) so that the gap between two adjacent plates (12) is changed. When pivoting the control knob (14) to engage with a side face defining the through hole (1), the gap between two adjacent plates (12) is in its maximum.

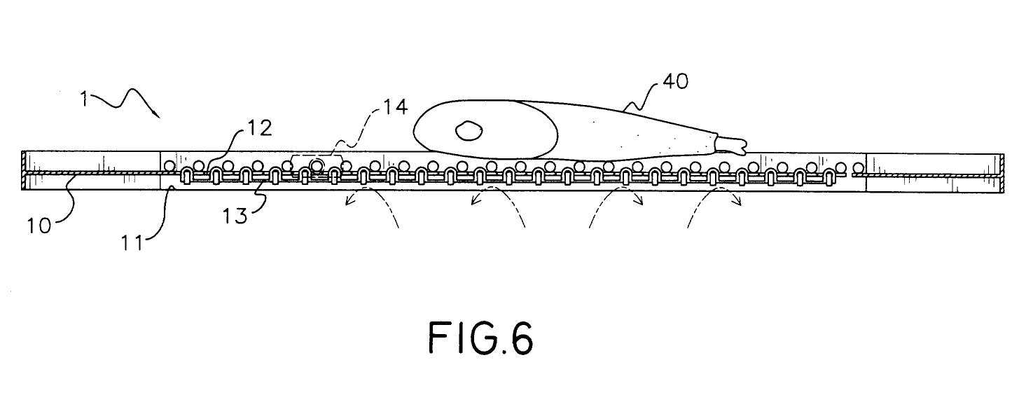

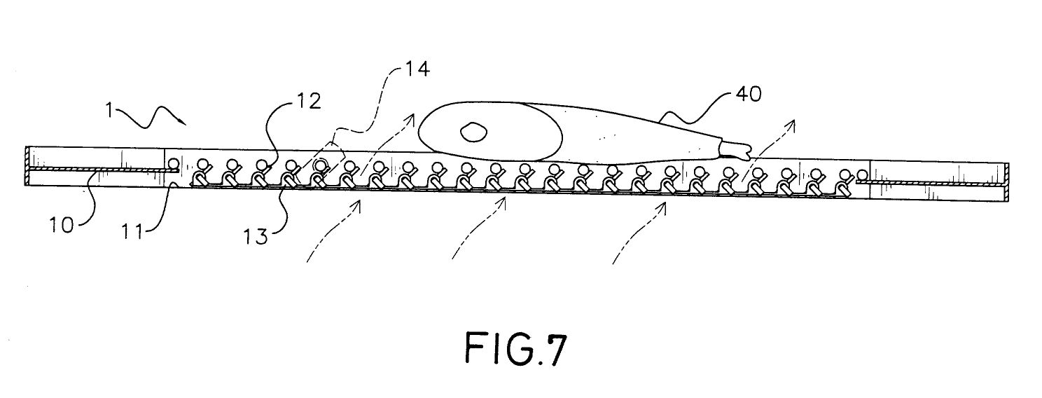

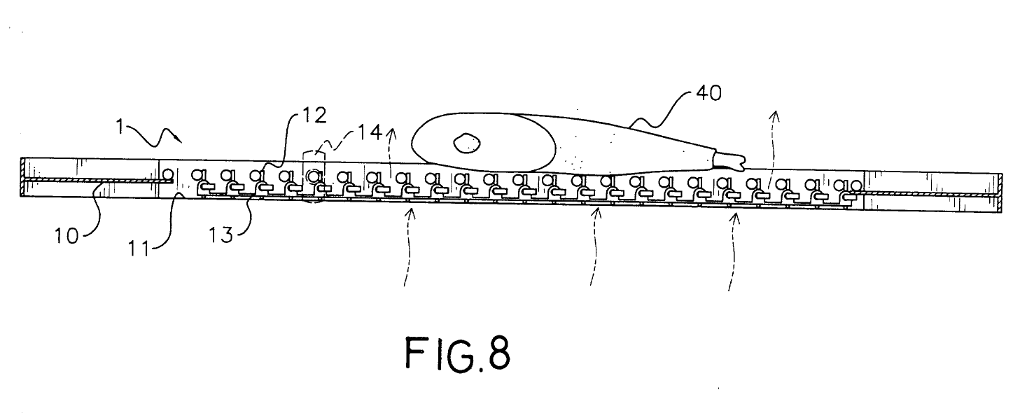

With reference to FIGS. 6, 7 and 8, when a food (40) is placed on top of the grill of the present invention, the user is able to close the gap so that the flame has no influence to the food (40) but the heat. When the food (40) needs to be roasted, the user is able to control pivotal movement of the control knob (14) so as to control the dimension of the gap between two adjacent plates (12) and therefore the influence of the flame volume to the food (40).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adjustable barbecue grill comprising:
a metal plate with a through hole defined in a center of the metal plate;
multiple plates pivotally arranged to cover the through hole;
multiple elongated pivoting bars each securely attached to a side of a corresponding one of the multiple plates;
two control bars pivotally connected to opposite distal ends of each of the multiple plates; and
a control knob securely connected to one of the multiple elongated pivoting bars so that pivoting movement of the control knob initiates pivotal movement of the multiple plates and thus a dimension of a gap defined between two adjacent plates is adjusted.
